(19) United States
(12) Patent Application Publication
(10) Pub. No.: US 2014/0234815 A1
(43) Pub. Date: Aug. 21, 2014

(54) APPARATUS AND METHOD FOR EMOTION INTERACTION BASED ON BIOLOGICAL SIGNALS

(71) Applicant: Electronics and Telecommunications Research Institute, Daejeon (KR)

(72) Inventors: Eun-Hye JANG, Sejong (KR); Sang-Hyeob KIM, Daejeon (KR); Byoung-Jun PARK, Iksan (KR); Chul HUH, Daejeon (KR); Myung-Ae CHUNG, Daejeon (KR)

(73) Assignee: Electronics and Telecommunications Research Institute, Daejeon (KR)

(21) Appl. No.: 14/070,358

(22) Filed: Nov. 1, 2013

(30) Foreign Application Priority Data
Feb. 18, 2013 (KR) 10-2013-0017079

(51) Int. Cl. G09B 19/00

(52) U.S. Cl. CPC G09B 19/00
USPC 434/236

(57) ABSTRACT

An emotion signal detecting apparatus is provided, and the emotion signal detecting apparatus comprises a sensor unit configured to detect a biological signal, which occurs due to a change in an emotional state of a user, and an environmental signal; and a control unit configured to generate emotion information based on the biological signal and the environmental signal and to transmit the generated emotion information to an emotion signal detecting apparatus or emotion service providing apparatus of a different user.

### CROSS-REFERENCE TO RELATED APPLICATION

This application claims the benefit under 35 U.S.C. §119(a) of Korean Patent Application No. 10-2013-0017079, filed on Feb. 18, 2013, in the Korean Intellectual Property Office, the entire disclosure of which is incorporated herein by reference for all purposes.

### BACKGROUND

1. Field

The following description relates to a technology of measuring biological signals, and more particularly a two-way interaction apparatus and method for maximizing emotion engagement based on biological signals.

2. Description of the Related Art

As more customers tend to be drawn to emotional products or services, leading companies are now opening their eyes to the benefits of an emotional communication technology and thus shifting their market strategies from performance- and price-oriented ones to customer convenience- and satisfaction-oriented ones, thereby leading to a customer emotional-oriented industry.

Conventional home appliances' primary role was delivering information, but the recent ones are focusing on providing content using which a user can enjoy by himself and communicate with others. For this reason, emotion interaction has become an indispensable technology. That is, there is a high demand on a technology of emotional interaction which senses emotion of a user and properly responds to the sensed emotion.

In order to actively respond to the emotion of a user, a technology able to a feeling of the user in real time is needed. In emotional engineering, it is possible to recognize emotion of a user by applying a recognition algorithm to a signal which is rectified using an eye movement, a facial expression, sensitivity adjectives for measurement of psychological responses and biological signal analysis.

Many attempts have been made to recognize emotion of a user, including an apparatus and method for recognizing emotion of a user by monitoring biological signals, a real-time comprehensive emotion evaluation, an emotion evaluating system using biological signals, and an emotion recognition-based apparatus and method. However, such conventional technologies simply check or recognize emotion of a user by measuring, analyzing and evaluating biological signals, and fail to provide a method allowing interaction between users or between a user and a product. In addition, emotional communication-related technologies of related arts merely focus on transferring and providing obtained emotion signals.

### SUMMARY

The following description relates to an emotional interaction apparatus and method capable of inferring and/or recognizing emotion of a user using biological signals, transferring the inferred and/or recognized emotion to a different user and/or apparatus for emotional communication.

In one general aspect, an emotion signal detecting apparatus is provided, and the emotion signal detection apparatus includes a sensor unit configured to detect a biological signal, which occurs due to a change in an emotional state of a user, and an environmental signal; and a control unit configured to generate emotion information based on the biological signal and the environmental signal and to transmit the generated emotion information to an emotion signal detecting apparatus or emotion service providing apparatus of a different user.

In still another general aspect, an emotional interaction method based on biological signals detected by an emotion signal detecting apparatus is provided, and the emotional interaction method includes measuring biological signals; extracting an emotion signal from each of the measured biological signals; generating emotion information, which indicates a current emotional state of a user, based on the extracted emotion signal; and transmitting the generated emotion information to an emotion signal detecting apparatus of a different user for a purpose of emotional interaction with the different user.

In yet another general aspect, an emotional interaction method based on biological signals detected by an emotion signal detecting apparatus is provided, and the emotional interaction method includes receiving current emotion information of a different user from an emotion signal detecting apparatus belonging to the different user; recognizing an emotional state of the different user based on the received emotion information; and displaying an expression so as to allow the user to recognize the recognized emotional state of the user.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an emotion signal communication system applied in the present invention;

FIG. 2 is a diagram illustrating a configuration of a transmitter according to an exemplary embodiment of the present invention;

FIG. 3 is a diagram illustrating a receiver according to an exemplary embodiment of the present invention;

FIG. 4 is a flow chart illustrating an emotional interaction method using biological signals according to an exemplary embodiment of the present invention;

FIG. 5 is a flow chart illustrating an emotional interaction method using biological signals when an emotion service is provided according to an exemplary embodiment of the present invention; and

FIG. 6 is a flow chart illustrating an emotional interaction method using biological signals when an emotion signal of a different user is received according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

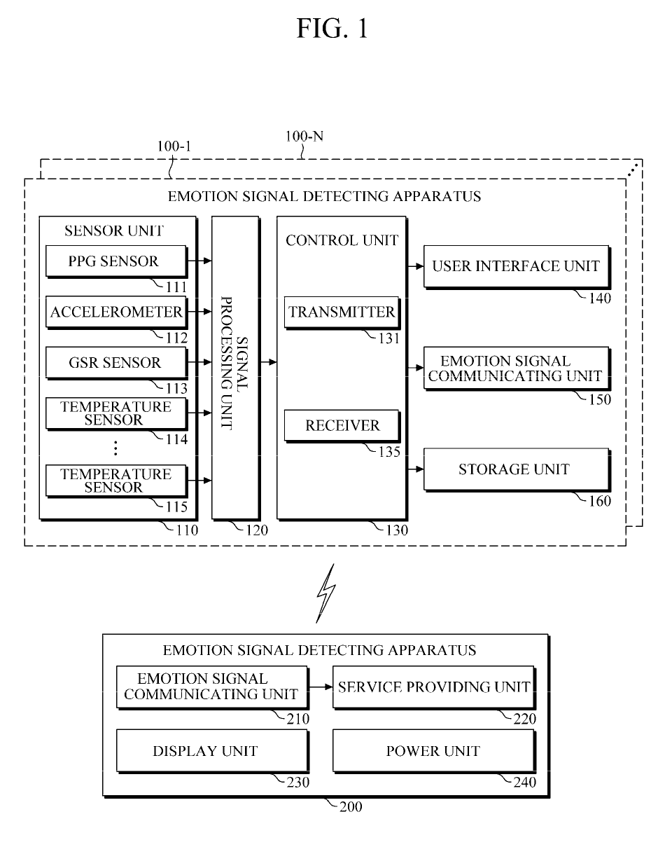

FIG. 1 is a diagram illustrating an emotion signal communication system used in the present invention.

Referring to FIG. 1, the emotion signal communication system includes two or more emotion signal detecting apparatuses 100-1, . . . , 100-N and an emotion service providing apparatus 200.

Each of the emotion signal detecting apparatuses 100-1, . . . , 100-N generates an emotion signal and/or emotion information by detecting a biological state or a surrounding environmental state of a user, and transmits the generated emotion signal and/or emotion information either to the emotion service providing apparatus 200 or to the other emotion signal detecting apparatuses 100-1, . . . , 100-N. At this point, a biological signal may include a brain wave, an electrocardiogram, a blood pressure, a Galvanic Skin Response (GSR) and a respiratory quotient.

Each of the emotion signal detecting apparatuses 100-1, . . . , 100-N may be attached to a body of a user or placed in a surroundings of the user so as to detect an emotion signal.

The emotion service providing apparatus 200 is placed in an area close to or distant from a user, and provides an emotion service to the user based on emotion signals received from the emotion signal detecting apparatuses 100-1, . . . , 100-N. The emotion service providing apparatus 200 may include a Personal Digital Assistant (PD), a mobile phone and a Personal Computer (PC). Each of the emotion signal detecting apparatuses 100-1, . . . , 100-N and the emotion service providing apparatus 200 may communicate with each other via a Bluetooth wireless communication. At this point, an emotion service refers to a service for providing content so as to control emotion of a user, and may include a video, a game, sound and music.

In more detail, the emotion signal detecting apparatus 100-1, . . . , 100-N includes a sensor unit 110, a signal processing unit 120, a control unit 130, a user interface unit 140, an emotion signal communicating unit 150 and a storage unit 160.

The sensor unit 110 detects a biological signal and an environmental signal of a user, which are generated in accordance with a change in emotion of the user, and outputs the detected biological signal and the detected environmental signal to the signal processing unit 120. Each of the detected biological signal and the detected environmental signal is an analogue signal, and thus hereinafter referred to as an analogue signal. The sensor unit 110 may include a Photoplethysmography (PPG) sensor 11 for extracting information about heartbeats of a user, an accelerometer 112 for extracting an accelerometer signal in accordance with movement of the user, a Galvanic Skin Response (GSR) sensor 113 for measuring a GSR which indicates an emotional state of the user, a temperature sensor 114 for detecting a body temperature and a surrounding temperature of the user, and a voice sensor 115 for detecting a voice of the user.

The signal processing unit 120 amplifies the analogue signal output from the sensor unit 110, removes noise from the amplified analogue signal, converts the amplified and noise-removed analogue signal into a digital signal, and outputs the digital signal.

The control unit 130 generates emotion information based on the digital signal output from the signal processing unit 120, and transmits the generated emotion information to the emotion signal communicating unit 150. At this point, the emotion information refers to information indicating a feeling of a user, such as joy, delight, sadness, fear and horror. The emotion information may be generated based on a body temperature, the number of heartbeats, a blood pressure level and a respiratory quotient of the user.

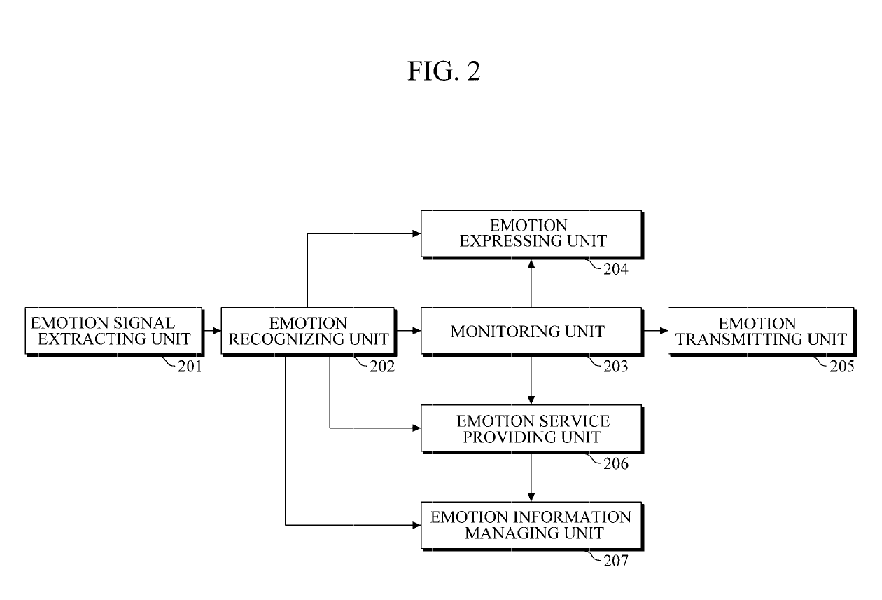

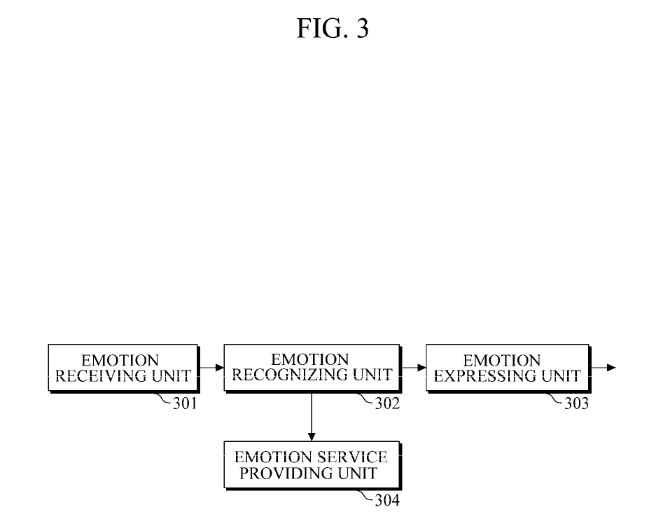

According to an exemplary embodiment of the present invention, the control unit 130 includes a transmitter 131 and a receiver 132 on a broad scale. Configurations of the control unit 130 will be described in detail with reference to FIGS. 2 to 3.

The user interface unit 140 expresses an operational state and data of the emotion signal detecting apparatus 100. The user interface unit 110 is a means by which an instruction is received from a user or a predetermined signal is output to the user. For example, the user interface unit 110 may be an input means, including a key pad, a touch pad and a microphone, and an output means including a Liquid Crystal Display (LCD).

The emotion signal communicating unit 150 transmits an emotion signal generated by the control unit 130 to the emotion service providing apparatus 200 through an emotion signal communication protocol. In more detail, the emotion signal communicating unit 150 transmits the emotion signal to the emotion signal detecting apparatus 100 or to surrounding terminals including the emotion signal detecting apparatus 100. At this point, during the communication with the emotion service providing apparatus 200, the emotion signal communicating unit 150 may perform security-processing on the emotion signal so as to secure privacy of the user. For example, the emotion signal communicating unit 150 may encrypt an emotion signal and emotion information.

The storage unit 160 stores an emotion signal to be used by the control unit 130, and may include a volatile memory and a non-volatile memory. The storage unit 160 stores predetermined mean biological signals and emotion information corresponding to each of the predetermined mean biological signals. A predetermined mean biological signal refers to an average of biological signal information measured with respect to a plurality of subjects. Biological signals of the subject people are classified into a plurality of emotional state categories in accordance with an emotional state of each subject. Each emotional state category is used as emotion information which corresponds to a mean biological signal. Using the emotional state category used as emotion information, the control unit 130 generates emotion information by analyzing biological signals. In addition, the storage unit 160 may store the emotion information recognized based on the analyzed biological, and emotion control information.

Next, the emotion service providing apparatus 200 includes an emotion signal communicating unit 210, a service providing unit 220, a display unit 230 and a power unit 240.

The emotion signal communicating unit 210 receives an emotion signal and/or emotion information from the emotion signal detecting apparatus 100 using an emotion signal communication protocol, and transmits the received emotion signal and/or emotion information to the service provider 220. In addition, the emotion signal communicating unit 210 receives a feedback signal from the service providing unit 220, and transmits the received feedback signal to the emotion signal detecting apparatus 100. At this point, the feedback signal includes a signal occurring from a user who receives an emotion-based service from an emotion service providing apparatus.

The service providing unit 220 provides an emotion service to a user based on the received emotion signal and/or emotion information, receives a feedback signal from the user, and transmits the feedback signal received from the user to the emotion signal communicating unit 210. The service providing unit 220 provides user with content, such as a video, a game, sound and music, so as to control an emotional state of the user, and receives a feedback of the emotional state controlled by the content. The display unit 230 displays an operation state and data of the emotion service providing apparatus 200. The storage unit 240 stores information used in the emotion service providing apparatus 200.

FIG. 2 is a diagram illustrating a configuration of a transmitter according to an exemplary embodiment of the present invention.

A transmitter 131 includes an emotion signal extracting unit 201, an emotion recognizing unit 202, a monitoring unit 203, an emotion expressing unit 204, an emotion transmitting unit 205, an emotion service providing unit 206 and an emotion information managing unit 207.

The emotion signal extracting unit 201 extracts emotion signals from among analogue signals received from the signal processing unit 120, by analyzing each of the analogue signals using a mathematical model-based analysis algorithm. In this way, it is possible to extract only signals having a predetermined threshold value from among measured signals as emotion signals. At this point, the predetermined threshold value may be determined according to a mean biological signal value stored in the storage unit 160.

In addition, before extracting the emotion signals, the emotion signal extracting unit 201 may detect an error in an emotion signal which is extracted by analyzing a state/environmental information. For example, if it is found that a signal which is extracted as an emotion signal does not affect emotion of a user or is beyond a reference range when time and environmental information are taken into account, it is possible to determine that an error has occurred in the emotion signal. The emotion signal extracting unit 201 compensates the error in the emotion signal. For example, the emotion signal extracting unit 201 may compensate an error in an emotion signal by using (for example, calculating an average of) both an emotion signal in which an error has occurred and an emotion signal in which an error has not occurred.

The emotion recognizing unit 202 generates emotion information describing a current emotional state of a user based on the emotion signal extracted by the emotion signal extracting unit 201.

The monitoring unit 203 monitors a change in the emotion information generated by the emotion recognizing unit 202 so as to check a change in the emotional state of the user.

The emotion expressing unit 205 generates an expression in response to the change in the emotional state, the change which is checked by the monitoring unit 203, and outputs the expression via the user interface unit 140. For example, the emotion expressing unit 105 displays a level of excitement of a user in the form of bar, or outputs voice saying ‘Calm down’ or ‘Watch yourself.’ At this point, the emotion signal communicating unit 150 may refer to feedback information received from the emotion service providing apparatus 200.

For interaction with a different user, the emotion transmitter 205 transmits current emotion information of a user to a different emotion signal detecting apparatus via the emotion signal communicating unit 150.

The emotion service providing unit 206 provides content so as to control emotion of the user in accordance with a change in emotion information, which is output from the monitoring unit 203, receives feedback information, and outputs the received feedback information. That is, the emotion service providing unit 206 selects an emotion caring service suitable for an emotional state of a user, and requests the selected emotion caring service from the emotion service providing apparatus 200.

The emotion information management unit 207 manages and stores an emotion signal, which is extracted from a biological signal, and emotion control information in the storage unit 160.

FIG. 3 is a diagram illustrating a configuration of a receiver according to an exemplary embodiment of the present invention.

The receiver 132 includes an emotion receiving unit 301, an emotion recognizing unit 302, an emotion expressing unit 303 and an emotion service providing unit 304.

The emotion receiving unit 301 receives emotion information of a different user from a different emotion signal detecting apparatus so as to allowing a user to be informed of an emotional state of the different user.

The emotion expressing unit 303 displays the emotional state of the different user, and provides information necessary to control emotion of the different user. For example, the emotion expressing unit 303 may display a level of excitement of the different user in the form of bar or output emotional expressions, such as “Calm down” and “Watch yourself”

If an emotion service is needed to control emotion of the different user, the emotion service providing unit 304 provides the emotion service. That is, the emotion service providing unit 304 analyzes emotion of a user, selects an emotion caring service suitable to an emotional state of the user according to an analysis result, and requests the selected emotion caring service from the emotion service providing apparatus 200.

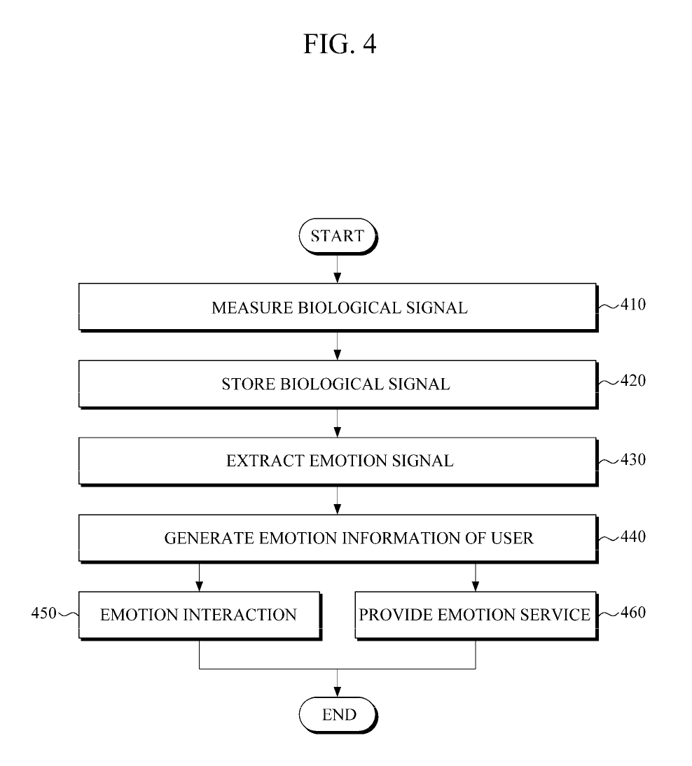

FIG. 4 is a flow chart illustrating an emotional interaction method using biological signals according to an exemplary embodiment of the present invention.

First of all, a user is attached with a plurality of biological signal measuring sensors, and the emotion signal detecting apparatus 100 measures biological signals of the user using the biological signal measuring sensors in 410. At this point, a biological signal may include at least one of a brain wave, an electrocardiogram, a blood pressure level, a GSR and a respiratory quotient

If biological signals are measured, the emotion signal detecting apparatus 100 stores the measured biological signals in 420 and then extracts emotion information which corresponds to a biological signal stored in the storage unit 160 in 430. At this point, the storage unit 160 has stored predetermined mean biological signals and an emotion signal corresponding to each of the predetermined mean biological signals in advance.

The emotion signal detecting apparatus 100 generates emotion information of a user using the extracted emotion signal in 440. The emotion information is generated using correlation between the mean biological emotion signal and the corresponding emotion information. At this point, the emotion information may represent at least one of anger, horror, sadness, disgust, joy or surprise of the user.

Lastly, the emotion signal detecting apparatus 100 transmits the emotion information to another emotion signal detecting apparatus 100 of a different user in 450. In addition, the emotion signal detecting apparatus 100 may allow a user to be provided with an emotion service which is able to control emotion of the user.

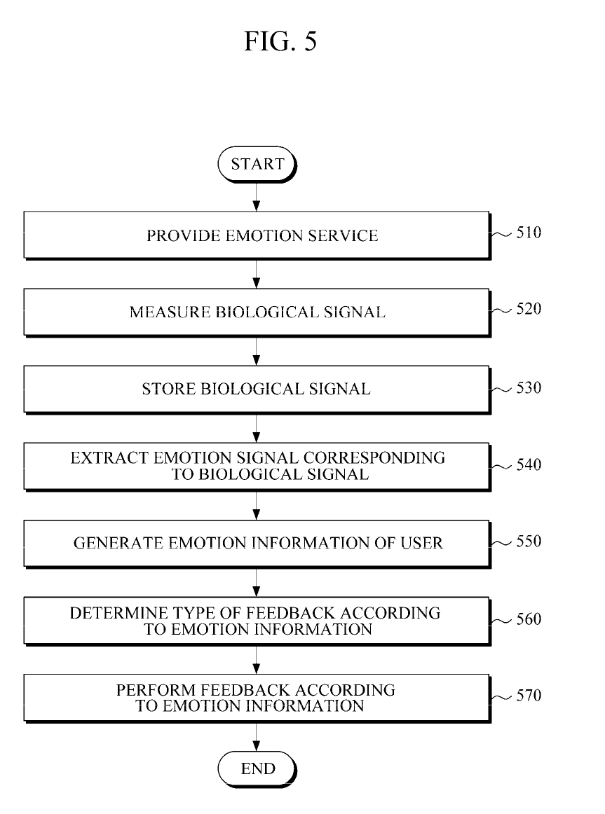

FIG. 5 is a flow chart illustrating an emotional interaction method using biological signals when an emotion service is provided, according to an exemplary embodiment of the present invention.

The emotion signal detecting apparatus 100 makes a user to be provided with a predetermined emotion service when the user is attached with a plurality of biological signal measuring sensors in 510.

During provision of the emotion service, the emotion signal detecting apparatus 100 measures biological signals using the biological signal measuring sensors in 520. At this point, a biological signal may include at least one of a brain wave, an electrocardiogram, a blood pressure level, a GSR and a respiratory quotient.

If biological signals are measured, the emotion signal detecting apparatus 100 stores the measured biological signals in 530, and extracts emotion signal corresponding to the biological signals stored in the storage unit 160 in 540. At this point, the storage unit 160 has stored predetermined mean biological signals and emotion information corresponding to each of the mean biological signals in advance.

The emotion signal detecting apparatus 100 generates information on an emotional state of a user using the extracted emotion signal in 550. The emotion information is generated based on collocation between mean biological signals and emotion information corresponding to each mean biological signal. That is, the emotion information may represent at least one of anger, horror, sadness, disgust, joy or surprise.

Next, the emotion signal detecting apparatus 100 determines a type of feedback, which is suitable to the emotion information, in 560. For example, the emotion signal detecting apparatus 100 may allow an emotion service or a message, which is able to control emotion of a user, to be provided.

Lastly, the emotion signal detecting apparatus 100 provides the user with a feedback suitable for the emotion information in 570.

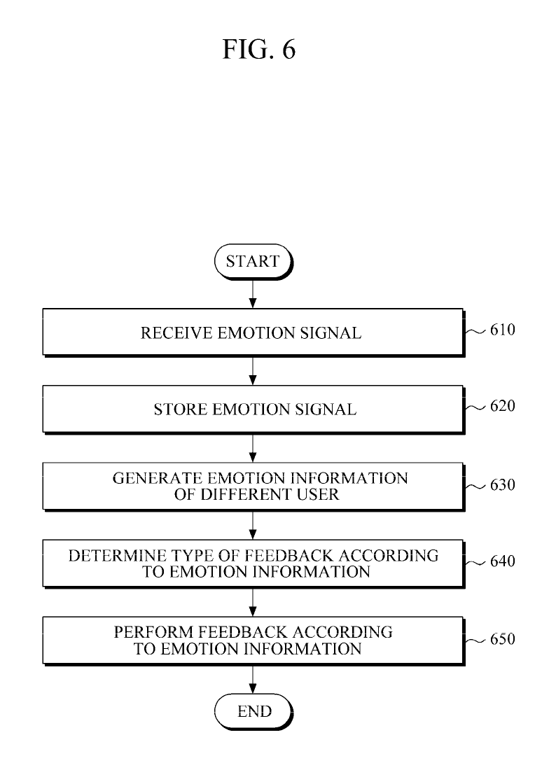

FIG. 6 is a flow chart illustrating an emotional interaction method using biological signals when an emotion signal of a different user is received, according to an exemplary embodiment of the present invention.

First, the emotion signal detecting apparatus 100 receives an emotion signal of a different user from a different emotion signal detecting apparatus in 610.

If biological signals are received, the emotion signal detecting apparatus 100 stores the received emotion signals in 620. The emotion signal detecting apparatus 100 generates emotion information of the different user using the received emotion signal in 630. The emotion information is generated based on correlation between a mean biological signal and emotion information corresponding to the mean biological signal. At this point, the emotion information may represent at least one of anger, horror, sadness, disgust, joy or surprise.

Next, the emotion signal detecting apparatus 100 determines a type of feedback, which is suitable for the emotion information, in 640. For example, the emotion signal detecting apparatus 100 may make the different user to be provided with an emotion service which is able to control emotion of the different user. Alternatively, the emotion signal detecting apparatus 100 may output a message, which is able to control emotion of the different user, to the different emotion signal detecting apparatus 100. Lastly, the emotion signal detecting apparatus 100 performs a feedback suitable for the emotion information of the user in 650.

When developing an emotion engineering-related product, such as an automobile, a mobile device, a virtual reality and a game, the present invention may accurately measure/analyze/recognize an emotional state of a user or transmit the result between people or between a user and a product, so that efficiency of a product or service may improve and an emotional interaction may be enabled.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An emotion signal detecting apparatus comprising:
a sensor unit configured to detect a biological signal, which occurs due to a change in an emotional state of a user, and an environmental signal; and
a control unit configured to generate emotion information based on the biological signal and the environmental signal and to transmit the generated emotion information to an emotion signal detecting apparatus or emotion service providing apparatus of a different user.

2. The emotion signal detecting apparatus of claim 1, wherein the sensor unit comprises a Photoplethysmography (PPG) sensor configured to extract information about heartbeats of the user;
an accelerometer configured to detect an accelerometer signal in accordance with movement of the user;
a Galvanic Skin Response (GSR) sensor configured to measure a GSR that indicates an emotional state of the user,
a temperature sensor configured to detect a body temperature of the user and a temperature surrounding the user; and
a voice sensor configured to detect a voice of the user.

3. The emotion signal detecting apparatus of claim 1, wherein the control unit comprises
a transmitter configured to transmit the emotion information, which is generated based on the measured biological signals, to the emotion signal detecting apparatus or emotion service providing apparatus of a different user, and
a receiver configured to receive emotion information from the emotion signal detecting apparatus of the different user and output the received emotion information.

4. The emotion signal detecting apparatus of claim 1, the transmitter comprises
an emotion signal extracting unit configured to extract an emotion signal from an analogue signal received from the sensor unit;
an emotion recognizing unit configured to generate emotion information, which indicates an emotional state of the user, based on the emotion signal extracted by the emotion signal extracting unit;
an emotion transmitter configured to transmit the emotion information generated by the emotion recognizing unit to the emotion signal detecting apparatus of the different user for a purpose of emotional interaction with the different user; and
an emotion service providing unit configured to select an emotion service so as to control the emotion information generated by the emotion recognizing unit, and to request the selected emotion service from the emotion service providing apparatus.

5. The emotion signal detecting apparatus of claim 4, wherein the transmitter further comprises a storage unit configured to store a predetermined mean biological signal and emotion information corresponding to the predetermined mean biological signal in advance,
wherein the emotion signal extracting unit extracts only emotion signals close to a mean biology signal stored in the storage unit among measured signals output from the sensor unit.

6. The emotion signal detecting apparatus of claim 4, wherein the emotion signal extracting unit detects an error in the extracted emotion signal and compensates the detected error.

7. The emotion signal detecting apparatus of claim 4, wherein the transmitter further comprises a monitoring unit configured to monitor a change in the emotion information generated by the emotion recognizing unit to check the emotional state of the user.

8. The emotion signal detecting apparatus of claim 7, wherein the transmitter further comprises an emotion expressing unit configured to generate an expression in accordance with the change in the emotion information, which is checked by the emotion monitoring unit, and display the generated expression to the user via a user interface unit.

9. The emotion signal detecting apparatus of claim 1, wherein the receiver comprises
an emotion receiver configured to receive emotion information of the different user from the emotion signal detecting apparatus belonging to the different user;
an emotion recognizing unit configured to emotion information
an emotion expressing unit configured to express an emotional state of the different user, which is recognized by the emotion recognizing unit.

10. The emotion signal detecting apparatus of claim 9, wherein the receiver further comprises an emotion service providing unit configured to select an emotion caring service suitable to the emotional state of the different user, which is recognized by the emotion recognizing unit, and requests the selected emotion caring service to the emotion service providing apparatus.

11. An emotional interaction method based on biological signals detected by an emotion signal detecting apparatus, the emotional interaction method comprising:
measuring biological signals;
extracting an emotion signal from each of the measured biological signals;
generating emotion information, which indicates a current emotional state of a user, based on the extracted emotion signal; and
transmitting the generated emotion information to an emotion signal detecting apparatus of a different user for a purpose of emotional interaction with the different user.

11. The emotional interaction method of claim 11, further comprising:
selecting an emotion caring service so as to control the generated emotion information and requesting the selected emotion caring service from an emotion service providing apparatus.

13. The emotional interaction method of claim 11, wherein the extracting of the emotion signals comprises extracting only emotion signals closed to a mean biological signal stored in a storage unit from among the measured biological signals.

14. The emotional interaction method of claim 11, further comprising monitoring a change in the generated emotion information for a predetermined length of time to check a change in the emotional state of the user.

15. The emotional interaction method of claim 11, further comprises
generating an expression in accordance with the checked change in the emotional state of the user and outputting the expression so as to allow the user to recognize the change.

16. An emotional interaction method based on biological signals detected by an emotion signal detecting apparatus, the emotional interaction method comprising:
receiving current emotion information of a different user from an emotion signal detecting apparatus belonging to the different user;
recognizing an emotional state of the different user based on the received emotion information; and
displaying an expression so as to allow the user to recognize the recognized emotional state of the user.

17. The emotional interaction method of claim 16, further comprising:
selecting an emotional caring service suitable for the recognized emotional state of the user, and requesting the selected emotional caring service from an emotion service providing apparatus.
